(19) United States
(12) Patent Application Publication
(10) Pub. No.: US 2010/0037563 A1
(43) Pub. Date: Feb. 18, 2010

(54) PACKAGING

(76) Inventor: Marc Luyten, Schilde (BE)

Correspondence Address: BACON & THOMAS, PLLC, 625 SLATERS LANE, FOURTH FLOOR, ALEXANDRIA, VA, 22314-1176, US

(21) Appl. No.: 12/539,844

(22) Filed: Aug. 12, 2009

(30) Foreign Application Priority Data
Aug. 12, 2008 (BE) 2008/0445

(51) Int. Cl. B65B 11/00; B32B 3/12

(52) U.S. Cl. 53/461; 428/116

(57) ABSTRACT

Packaging for a pallet (3) of goods or products (1), which are either or not packed, characterised in that the packaging (4) is made as a preformed cloth or preformed cover with a thermally insulating structure and having dimensions which make it possible to cover the pallet (3) of goods (1) on the sides and on the top side and the bottom side to thermally insulate the goods (1) temporarily in a non-conditioned space, whereby the packaging (4) is such that when the packaging (4) is provided around the pallet (3) of goods, the provided packaging (4) protects the goods almost entirely from the outside air and that there is at least one air bubble and/or air layer (7) between the packaging (4) and the goods and/or in the packaging (4).

The present invention concerns a packaging.

In particular, the invention concerns a packaging of products or goods that must be protected against temperature shocks or temperature variations, or against prolonged exposure to temperatures that are too high or too low in a non-conditioned environment.

Examples of such products are vaccines, organs and the like, as well as foodstuff such as chocolate, flowers or any other product which can be permanently damaged due to temperatures that are too high or too low,

This is for example important when transferring the products at airports or the like, where the products are unloaded for example from a cold storage truck and remain in transit in a non-protected area for a certain time while waiting to be loaded in the airplane and are exposed to normal ambient temperatures outside,

As such it is known that for example vaccines should be stored by a temperature preferably between 2 and 8° C. or that chocolate is preferably stored at a temperature between 14 and 18° C.

Of course, the invention is not restricted to the above-mentioned applications, but a packaging according to the invention can also be used for packing other products for which the temperature is preferably held in a completely different temperature range.

It is known for products such as vaccines or medicines or the like, which need to be protected against temperature shocks or temperature variations, to be packed in an envelope made of thermally insulating material.

A disadvantage of the use of such an envelope, however, is that the envelope can only contain one product or possibly only a small number of products having a relatively restricted volume, as a result of which it is time-consuming to pack a large number of products. Moreover, it is not possible to protect voluminous temperature-sensitive products with such envelopes.

It is also known that the transport of thermally sensitive products becomes more problematic as the transport process is lengthier, since the risk of transhipments occurring in environments which are not thermally controlled or which cannot be thermally controlled rises, where the product may then be consequently exposed to temperature shocks or temperature variations.

The present invention aims to remedy one or several of the above-mentioned and/or other disadvantages

To this end, the present invention concerns a packaging for a pallet of goods or products, either or not packed, whereby the packaging is made as a preformed cloth or as a preformed cover with a thermally insulating structure and with dimensions making it possible to cover the pallet of goods on the sides and on the top and bottom sides to thermally insulate the goods temporarily in a non-conditioned space, and whereby the packaging is such that when it is provided around the pallet of goods, the provided package protects the goods almost entirely from the outside air and that there is at least one air bubble and/or air layer between the packaging and the product and/or inside the packaging.

An advantage is that a packaging according to the invention offers a good and relatively lengthy temporary protection against temperature shocks or temperature variations, as a result of which the packed products do not risk any danger during waiting periods in environments which are not temperature-controlled.

Another advantage related thereto is that the packaging according to the invention allows to restrict, to reduce or to slow down any external influence on the packed goods.

Another advantage is that with a cover according to the invention, a large number of products can be packed at once, in particular when the product to be packed is not too voluminous. Further, a cover according to the invention is also appropriate for packing a temperature-sensitive product which is relatively bulky, for example a product or products which are stacked on a transport pallet.

An additional advantage is that a packaging according to the invention can be easily provided around and underneath the product to be protected, such that little time and accompanying labour costs are wasted.

Consequently, the packaging according to the invention offers the advantage that packed goods are completely protected from the outer environment,

In a preferred embodiment, the packaging is made as a two-piece cover formed of a first part which is pushed around the product and a second part which completes the packaging. The second part is hereby attached to the first part and it can be made as a loose part or as a flap which is folded over,

The present embodiment offers the advantage that the product can be packed without actually being touched, for example when the product has already been put in a casing by the manufacturer, which casing is not temperature-insulating.

The present embodiment is also advantageous in that, as a result, the packaging process is made much simpler and faster, such that the transport process can be speeded up.

According to the most preferred embodiment, the packaging according to the invention has such dimensions that the product or the products, together with the pallet on which they are stacked, can be entirely enclosed in the packaging.

The invention also concerns a method for packing thermally sensitive products in a packaging whereby the packed goods are thermally insulated from the outside.

According to the most practical embodiment of a method according to the invention, a two-piece packaging is used with a first part and a second part, whereby the method further comprises at least the following steps:

providing the first part of the packaging around the sides and the top side of the at least one product;

placing the second part of the packaging on an underground;

placing the at least one product to be packed on the second part of the packaging; and,

attaching the first part and the second part of the packaging to one another in order to protect the product entirely or almost entirely from the outside air.

In order to better explain the characteristics of the invention, the following embodiment of a packaging according to the invention is described by way of example only without being limitative in any way, with reference to the accompanying drawings, in which:

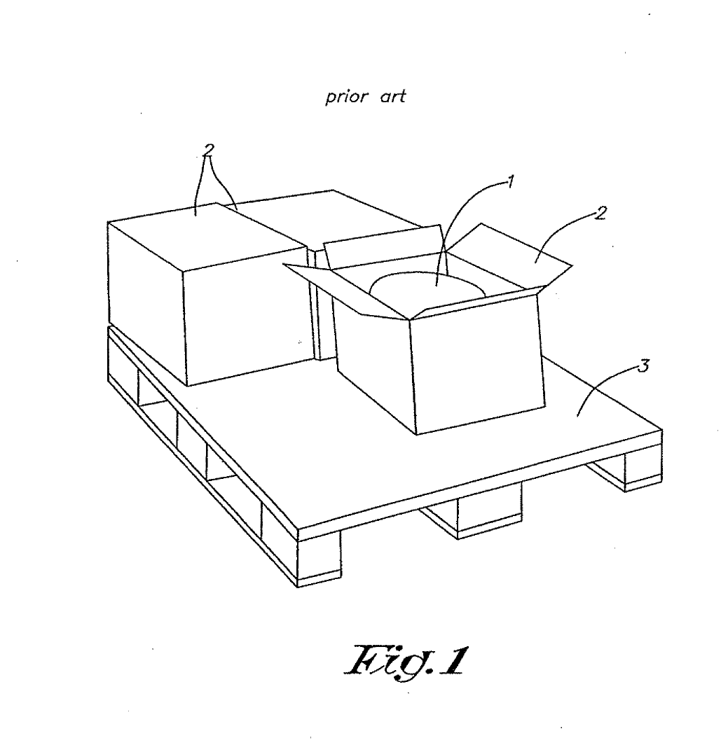

FIG. 1 shows a pallet in perspective with a number of temperature-sensitive products or goods to be protected on it, packed in the conventional manner without any packaging according to the invention;

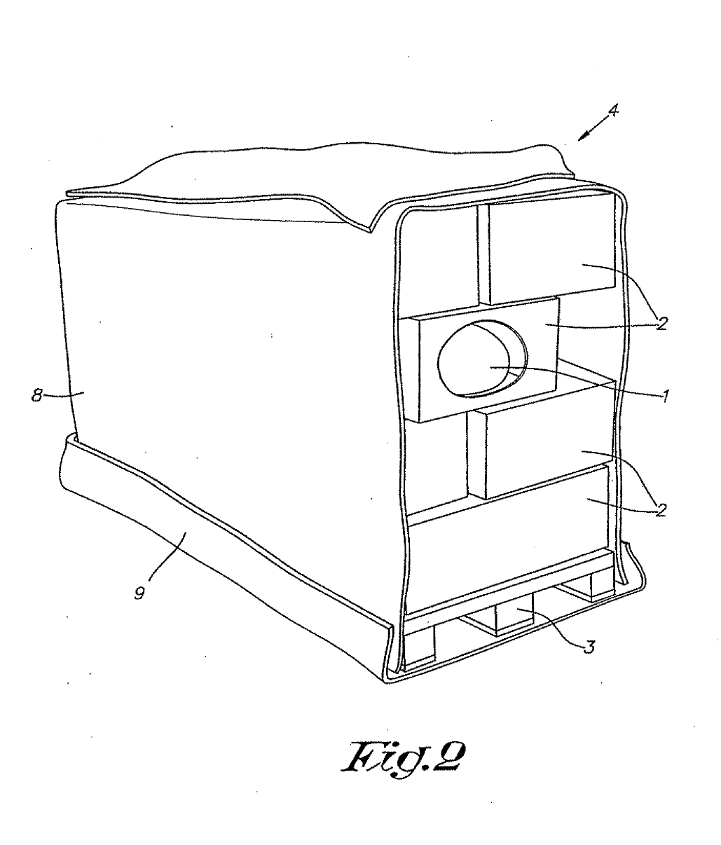

FIG. 2 shows a packaging according to the invention in perspective and with omission of certain parts, which packaging has been partly provided over said products;

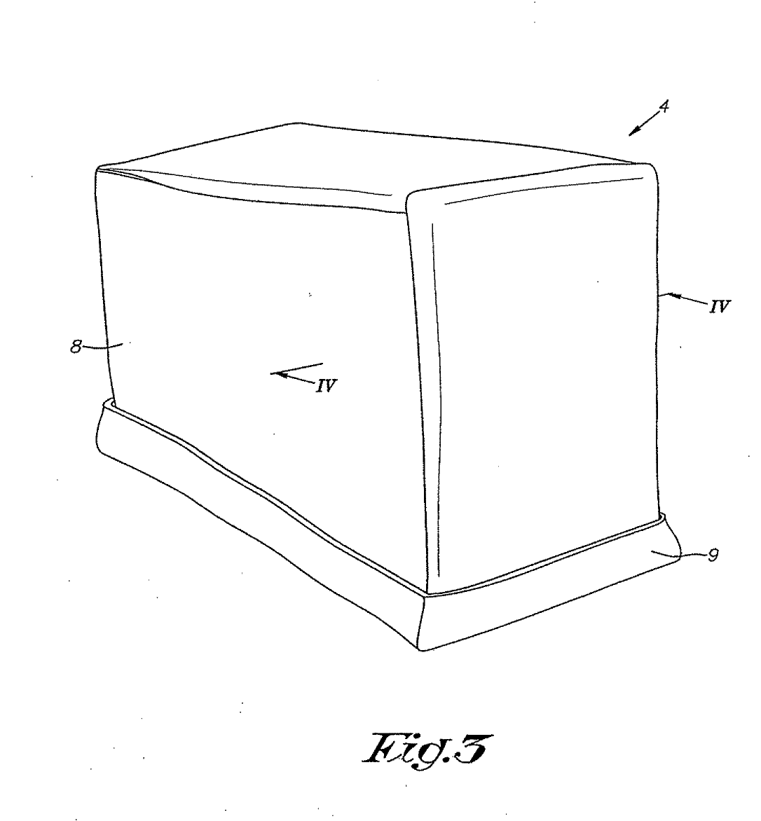

FIG. 3 shows a packaging according to the invention in perspective which has been entirely provided, ready for transport;

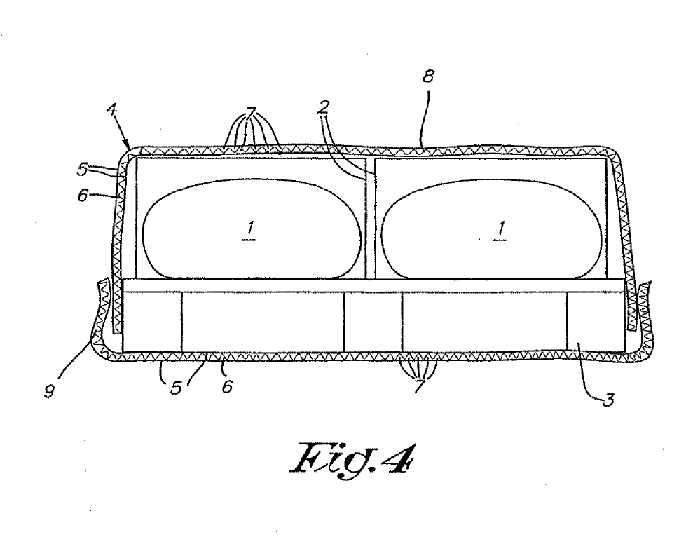

FIG. 4 is a cross section according to line IV-IV in FIG. 3, but for a pallet stacked to a lower height;

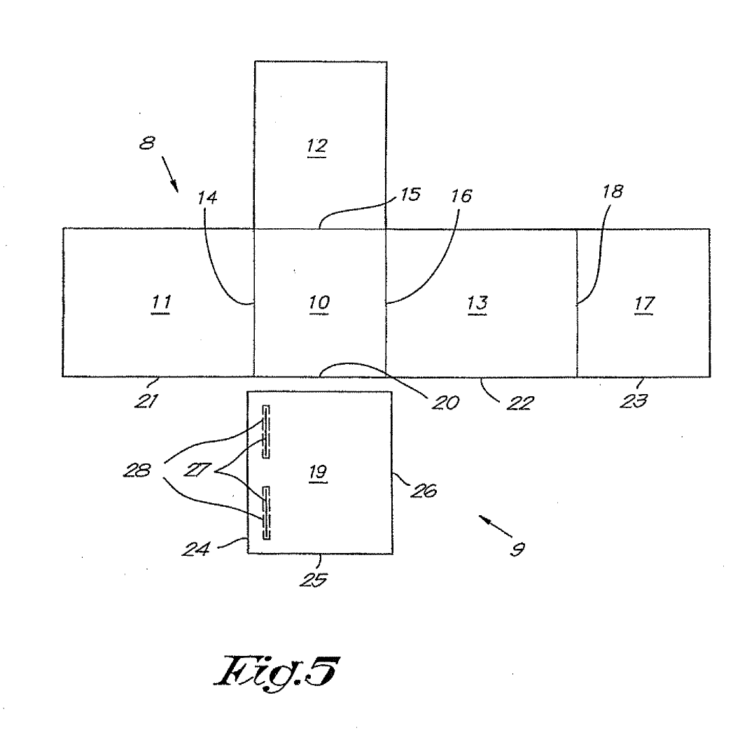

FIG. 5 is a top view of a possible embodiment of an unfolded packaging according to the invention;

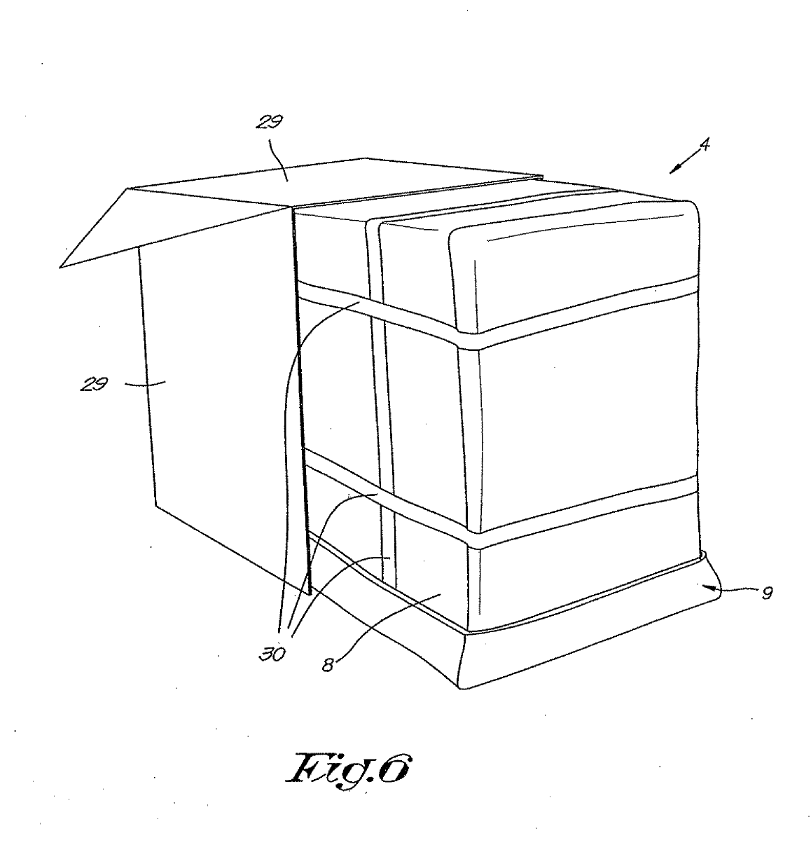

FIG. 6 shows accessories in perspective which can be provided around the packaging, ready for transport.

FIG. 1 shows how, according to the present state of the art, a packed pallet of goods in the form of a number of products 1 are each placed in a casing 2 or box on a pallet 3. The casing 2 is hereby not or hardly thermally insulating, and consequently, the products 1 are not sufficiently protected against possible temperature shocks or temperature variations occurring during the transport process.

FIG. 2 shows how a packaging 4 according to the invention is provided around said products, whereby this packaging 4 has been completely provided around the products 1 in FIG. 3, more specifically on the top and the bottom side and also along the sides. Consequently the products are ready for transport.

The cross section in FIG. 4 shows more clearly how a packaging 4 according to the invention can be provided over a number of products 1, casings 2 and a pallet 3 included, but the invention does not exclude that the packaging 1 may contain or enclose merely products 4.

The packaging 4 is in this case made as a cloth or cover with a thermally insulating structure. This structure as such may consist of a combination of different materials, but preferably it has at least one air layer or a layer of air bubbles.

As shown in FIG. 4, such a structure is for example made of two layers of aluminium 5 which are separated by means of a honeycomb structure 6 made of a polyolefin such as polyethylene enclosing air bubbles 7. This type of structure 6 is also called a physically or chemically branched polyolefin foam.

It is clear that when the structure is made as one layer of aluminium 5 having for example a structure 6 of profiled insulation material 6, air layers 7 (instead of air bubbles) are created between the packaging 4 and at least one product 1. In case of a symmetrical honeycomb structure 6, one can also speak of a combination of air bubbles and air layers 7.

In view of the reflecting properties of aluminium, it is clear that, thanks to this structure, the packed goods are shielded from the influence of the sun light in case of exposure of the pallet with goods to the sun.

It is clear that the nature of the structure can be realised in different ways, for example by applying blisters, and that the structure can also be multi-layered, whereby the layers can be separated by an air layer if required.

The structure will partly determine the insulating value of the packaging, and thus also for what length of time the product packed in it will be protected against any influences of the ambient temperature. The material and the structure will have to be in accordance with the aimed protection for the product, such as for example the length of exposition of the product above a set temperature value.

An insulating value of 4.8 kW/² may be sufficient for many applications having a structure as described above. A higher insulating value of 5.7 kW/m² may for example be obtained with a structure of two layers of aluminium, separated by two layers having an air bubble structure, separated in turn by a layer of polyethylene (PE).

It is clear for a person skilled in the art that the insulating value of the packaging is chosen in view of among others the goods to be packed and/or the temperature whereby these goods need to be stored.

Of course also outside environmental conditions such as heat, cold, incident sunlight or the like, may be considered by this choice.

The method for packaging at least one product 1 with a packaging 4 according to the invention is simple and can be explained as follows by means of FIGS. 1 to 4 included

When a number of products 1 must be transported, they are usually placed in casings 2 on a pallet 3 for transport, as shown in FIG. 1. According to that state of the art, the products 1 are not or not sufficiently protected against any possible temperature variations, however.

Consequently, the method according to the invention consists in providing a packaging 4 as described above over the products 1, as shown in FIG. 2, and around the products 1 and their casings 2, as shown in FIG. 3, such that there is at least one air bubble or air layer 7 in the packaging 4 or between the packaging 4 and the products 1 in view of their thermal insulation.

As shown in the top view of FIG. 5, whereby the packaging of FIG. 3 is unfolded, the packaging 4 is made for example in two pieces in the shape of a first part 8 and a second part 9.

In FIG. 5, the first part 8 of the packaging 4 according to the invention has the shape of a rectangular central surface 10 and three rectangular lateral faces 11, 12, 13 connected thereto along three of the four sides 14, 15, 16 of the central surface 10. Moreover an additional rectangular face 17 is provided, adjacent to one of said rectangular lateral faces 13, more in particular at side 18 of the lateral face 13 opposite to side 16 with which it is adjacent to the central surface 10.

The rectangular face 12 is intended to form the top side of the packaging 4, whereas the faces 10, 11, 13 and 17 are intended to form the lateral sides of the packaging 4.

The second part 9 has the shape of a rectangle 13 and is intended to form the bottom of the packaging 4.

Hence, the method for packing thermally sensitive products 1 in a packaging 4 according to the invention which is made in two pieces consists in first providing the first part 8 and then attaching the second part 9 of the packaging 4 to the first part 8, such that the products 1 are entirely wrapped in the packaging 4.

In the embodiment according to FIGS. 2 to 5 included, the second part 9 is attached to the fourth side 20 of the central surface 10 of the first part 8, whereby the rectangular surface 19 of the second part is practically just as large as or somewhat larger than the lateral face 12 across which it has been diametrically provided in relation to the central surface 10.

Optionally, the second part 9 is not only attached to one side 20 of the central surface 10 when using the packaging 4, but also to one side 21, 22 and 23 of the connecting lateral faces 11, 13 and 17 respectively,

The second part 9 can for example be attached to the first part 8 by means of known techniques such as gluing or stapling or by means of adhesive tape or with known detachable fastening means provided on both parts, for example in the shape of Velcro®, not shown in the figures.

The second part 9 preferably is an integral part of the first part 8, however, and the second part 9 is then made as a fourth lateral face 19, either or not with the above-mentioned fastening means, such as for example Velcro, on the sides 24, 25 and 26 which can co-operate with fastening means on the sides 20 and 21, 22 and 23 of the connecting lateral faces 11, 13 and 17.

This is advantageous in that the second part 9 cannot get lost and in that it can just be lowered as a flap when packing the products 1.

It is not excluded for the faces 11 and 12 and the faces 12 and 13, as well for the faces 12 and 17 to be connected along a common edge, for example by means of stitching, so as to form a sort of hood with four vertical walls which can be pulled over the products.

In the example of FIG. 5 the dimensions of the bottom 19 are larger than those of a pallet 3, such that its edges can be folded up so as to form a tub.

This second part 9 which is acting as the bottom 19 may also be preformed in the shape of a tub in which a pallet 3 which is already loaded can be placed, and which is provided with standing edges enclosing the pallet 3 along the edges and onto which the first part 8 of the packaging can be attached, for example by means of Velcro or adhesive tape, such that the loaded pallet 3 is packed in an almost completely heat-insulating manner in the packaging 4.

Therefore the use of said tub-shaped element underneath the pallet with goods allows to protect the goods efficiently against external influences from the bottom side.

In the standing edges can be provided one or several cuts 27 for the forks of a fork-lift truck or the like, which cuts 27 may be provided with a mark for the fork-lift driver. This mark can for example be provided on an adhesive strip 28 provided over the cut 27 such that, as long as the pallet 3 with goods 1 has not been moved with a fork-lift truck, the cuts are covered.

Obviously, it is also possible to use materials with different insulating values for the tub-shaped bottom 19 and the packaging 4.

In case of a packaging as that of FIG. 7, a pallet 3 loaded with products 1 is first covered with the first part 8 of the packaging after which the pallet 3 is placed on the bottom 19r and both parts 8 and 9 are sealed with adhesive tape or the like to their connection.

According to the invention, it is not excluded to work in the opposite way, whereby the pallet 3 is first placed on the bottom 19, after which the first part 8 is provided and both parts 8 and 9 are attached to one another.

By packing the pallet with goods in said manner, it is practically excluded that hot air may rise from between the blocks of the pallet to the goods present on said pallet.

Preferably, the bottom 19 is hereby shaped as a tub with edges which are folded up, whereby these edges can be attached to the first part 8 by means of adhesive tape or the like, such that the packed goods 1 are entirely enclosed in a thermally insulating jacket.

The cuts 27 make it possible to move the goods as a whole inside the packaging by means of a fork-lift truck, whereby any possible adhesive strips 28 then indicate where the cuts 27 are situated and where the fork-lift driver can perforate the adhesive strips 28 with the forks of his fork-lift truck so as to pick up the pallet 3.

It is clear, however, that a packaging 4 can be used in all sorts of shapes and dimensions, but the essence of the invention is that the packaging 4 is provided for at least one product 1, whereby at least one air bubble and/or air layer 7 is present in the packaging 4 or between the packaging 4 and the at least one product 1.

It is clear that for the transport of goods by means of different means of transport the packaging 4 may be adapted during transport.

In a practical example, whereby goods have to be transported first by truck and afterwards by plane, it is possible to provide first only a packaging 4 around the pallet 3 with goods I.

When unloading the truck, the pallet 3 with goods 1 can be placed on a bottom 19 and this bottom 19 can be attached to the packaging provided around the pallet 3 and can subsequently the whole can be loaded in the plane in this way.

It is clear that the thermal insulation qualities of a packaging 4 according to the invention can be adjusted depending on the circumstances, taking into account factors such as for example the required temperature range at which the at least one product 4 must be stored, the duration of the transport process and to what degree the product 4 is exposed to an environment which is not thermally controlled.

Qualities of the packaging 4 which may be changed are for example the selections thickness and composition of the materials that are used in the thermally insulating structure of the packaging 4.

The thermal insulating qualities can be improved by providing additional accessories. FIG. 6 shows for example how an additional cardboard 29 or for example a water-repellent material can be provided around the packaging 4 and how the packaging 4 can be sealed in a better way with strips of adhesive tape 30.

The adhesive tape 30 seals the at least one air bubble or air layer 7 that is present in a better way, as a result of which the insulating qualities of the packaging 4 are improved.

The cardboard 29 provides for an additional air layer between the cardboard 29 and the packaging 4, as a result of which the insulating qualities are improved as well.

In a practical example of a packaging 4 according to the invention, the aim is for example to store at least one product 4 within a temperature range of 2° C. to 8° C. for a period of 90 to 150 minutes, depending on the outside temperature of the non-controlled environment to which the product 1 in the packaging 4 is exposed.

Another accessory which may help to maintain the temperature of the product in the packaging 4 for a longer period of time is a cold source which can be temporarily packed together with the products in the packaging 4, as a result of which the products 1 will stay cold longer if they need to be temporarily stored in a warmer environment. An example of such a cold source is a Peltier element or another passive or active element.

When the products need to be temporarily stored in a rather cold environment, for example in an environment where freezing temperatures prevail, and the product needs to be protected against the cold, a passive or active heat source can be temporarily packed together with the products in a packaging 4 according to the invention in an analogous way.

The present invention is by no means restricted to the embodiment described by way of example and represented in the figure; on the contrary, such a packaging 4 according to the invention can be made in all sorts of ways while still remaining within the scope of the invention.

1. Packaging for a pallet of goods or products, which are either or not packed, said packaging comprising a preformed cloth or preformed cover with a thermally insulating structure and having dimensions which enable it to cover of goos on the sides and on the top side and the bottom side to thermally insulate the goods temporarily in a non-conditioned space, said packaging, when the packaging is provided around the pallet of goods, protects the goods almost entirely from the outside air and provides at least one air bubble and/or air layer between the packaging and the goods and/or in the packaging.

2. Packaging according to claim 1, formed of a material which is provided with an air layer or a layer of air bubbles.

3. Packaging according to claim 1, wherein the packaging comprises two layers of aluminum which are separated by a honeycomb structure comprising a polyolefin enclosing air bubbles and/or air layers.

4. Packaging according to claim 1, wherein the packaging comprises two pieces and is formed of a first part and a second part, wherein the second part is fastened to the first part.

5. Packaging according to claim 4, wherein the first part has the shape of a rectangular surface with three rectangular lateral faces on three sides of a central surface, and comprising an additional rectangular face adjacent to one of said rectangular side faces and the second part has the shape of a rectangular surface.

6. Packaging according to claim 1, dimensioned such that the packaging encloses the pallet of goods on all sides.

7. Packaging according to claim 6, including a bottom on which the pallet of goods can be placed.

8. Packaging according to claim 7, wherein the bottom is made such that is dimensions are larger than the dimensions of the pallet, such that edges of the bottom are foldable upwardsly around the pallet.

9. Packaging according to claim 8, wherein the bottom is made as a tub-shaped element adapted to receive the pallet of goods to be protected.

10. Packaging according to claim 9, the tub-shaped element having dimensions which substantially correspond to those of a pallet which is receivable in the tub-shaped element.

11. Packaging according to claim 9, wherein the bottom is provided with one or several cuts for the forks of a fork-lift truck, and which optionally are covered with an adhesive strip.

12. Method for packing thermally sensitive products in a packaging according to claim 1, comprising the steps: the packaging (4is provided and/or wrapped around and on the bottom side of at least one product, such that the provided packaging protects the products almost entirely from the outside air.

13. Method according to claim 12, including using a two-piece packaging with a first part and a second part and carrying out the steps:
providing the first part of the packaging around the sides and the top side of said at least one product;
placing the second part of the packaging on a surface an;
placing the at least one product to be packed on the second part;
attaching the first part and the second part to one another in order to protect the product entirely or almost entirely from the outside air.

14. Method according to claim 12, wherein all parts of the packaging are attached to one another.
